(19) United States
(12) Patent Application Publication
(10) Pub. No.: US 2025/0111013 A1
(43) Pub. Date: Apr. 3, 2025

(54) INFORMATION GENERATION METHOD AND APPARATUS, AND ELECTRONIC DEVICE

(71) Applicant: Huizhou Power Supply Bureau of Guangdong Power Grid Co., Ltd., Guangdong (CN)

(72) Inventors: Xiaoming GAO, Guangdong (CN); Qin LIU, Guangdong (CN); Huihong LI, Guangdong (CN); Fang CHEN, Guangdong (CN); Shidi LIU, Guangdong (CN); Yi YAN, Guangdong (CN); Cong MAI, Guangdong (CN); Jinming ZENG, Guangdong (CN); Yunzhi LIU, Guangdong (CN); Wenhao TAN, Guangdong (CN); Guangwen CAI, Guangdong (CN); Huiying DENG, Guangdong (CN); Xiaoming XU, Guangdong (CN); Yunbin SU, Guangdong (CN); Xueming JIANG, Guangdong (CN); Liyou ZHANG, Guangdong (CN); Mingyi GUO, Guangdong (CN); Jiechao LIAO, Guangdong (CN); Xuehao LI, Guangdong (CN)

(21) Appl. No.: 18/843,242

(22) PCT Filed: Jan. 3, 2023
(86) PCT No.: PCT/CN2023/070027

§ 371 Date: Aug. 31, 2024

(30) Foreign Application Priority Data
Mar. 1, 2022 (CN) 202210189132.8

(51) Int. Cl. G06Q 10/0631

(52) U.S. Cl. CPC G06F 18/24; G06F 16/35

(57) ABSTRACT

Provided are an information generation method and apparatus, and an electronic device. The method includes: acquiring a plurality of pieces of updated to-be-processed data in an original information list, wherein each piece of the to-be-processed data comprises a plurality of pieces of to-be-processed sub-data; acquiring pieces of to-be-matched sub-data whose list header is a work order number and determining that a work order stock list does not comprise target to-be-matched sub-data of the to-be-matched sub-data; determining a target execution user corresponding to each piece of the target to-be-matched sub-data and splicing target to-be-processed data corresponding to each piece of the target to-be-matched sub-data into an information generation list; and generating, based on an information list header in the information generation list, target prompt information corresponding to each piece of the target to-be-processed data and sending the target prompt information to a client corresponding to the target execution user.

The present application claims priority to Chinese Patent Application No. 202210189132.8 filed Mar. 1, 2022, the disclosure of which is incorporated herein by reference in its entirety.

### TECHNICAL FIELD

Embodiments of the present application relate to the field of data processing technology, for example, an information generation method and apparatus, and an electronic device.

### BACKGROUND

Staff engaged in marketing often need to deal with work orders. Pieces of work order information need to be sent to relevant working staff to guarantee the smooth progress of the work.

At present, the reminding of pieces of work order information is usually implemented through short messages. However, only specific pieces of work order reminding information can be sent to work order executors through the reminding manner of short messages. When the content of a piece of work order information changes, a piece of work order reminding information may be inaccurate due to that a corresponding short message are not updated in time. Moreover, when the short message function in a work order management system is abnormal, working staff cannot know a to-do link corresponding to the work order. Alternatively, when the short message communication service of a communication operator is abnormal, no backup solution can be used.

The manner of work order reminding needs to be improved to remind working staff of work orders in time so that working staff are prevented from missing work order reminders and failing to complete working nodes smoothly.

### SUMMARY

The present application provides an information generation method and apparatus, and an electronic device to implement the effect of automatically generating a piece of work order reminding information and determining whether the piece of work order reminding information is already received.

In a first aspect, embodiments of the present application provide an information generation method. The method includes the following.

A plurality of pieces of updated to-be-processed data in an original information list are acquired, where a piece of to-be-processed data includes a plurality of pieces of to-be-processed sub-data, and each of the plurality of pieces of to-be-processed sub-data is stored correspondingly according to a corresponding list header.

A piece of to-be-matched sub-data whose list header is “work order number” is acquired, and it is determined that a work order stock list does not include a piece of target to-be-matched sub-data of the piece of to-be-matched sub-data.

A target execution user corresponding to the piece of target to-be-matched sub-data is determined, and a piece of target to-be-processed data corresponding to the piece of target to-be-matched sub-data is spliced into an information generation list.

A piece of target prompt information corresponding to the piece of target to-be-processed data is generated based on an information list header in the information generation list, and the piece of target prompt information is sent to a client corresponding to the target execution user.

In a second aspect, embodiments of the present application provide an information generation apparatus. The information generation apparatus includes a to-be-processed data acquisition module, a target to-be-matched sub-data determination module, a target to-be-processed data splicing module, and a target prompt information sending module.

The to-be-processed data acquisition module is configured to acquire a plurality of pieces of updated to-be-processed data in an original information list, where a piece of to-be-processed data includes a plurality of pieces of to-be-processed sub-data, and each of the plurality of pieces of to-be-processed sub-data is stored correspondingly according to a corresponding list header.

The target to-be-matched sub-data determination module is configured to acquire a piece of to-be-matched sub-data whose list header is “work order number” and determine that a work order stock list does not include a piece of target to-be-matched sub-data of the piece of to-be-matched sub-data.

The target to-be-processed data splicing module is configured to determine a target execution user corresponding to the piece of target to-be-matched sub-data and splice a piece of target to-be-processed data corresponding to the piece of target to-be-matched sub-data into an information generation list.

The target prompt information sending module is configured to generate, based on an information list header in the information generation list, a piece of target prompt information corresponding to the piece of target to-be-processed data and send the piece of target prompt information to a client corresponding to the target execution user.

In a third aspect, embodiments of the present application further provide an electronic device. The electronic device includes one or more processors and a storage apparatus configured to store one or more programs.

When executed by the one or more processors, the one or more programs cause the one or more processors to perform the information generation method according to any embodiment of the present application.

### BRIEF DESCRIPTION OF DRAWINGS

FIG. 1 is a flowchart of an information generation method according to an embodiment of the present application.

FIG. 2 is a flowchart of the information generation method according to another embodiment of the present application.

FIG. 3 is a structural diagram of an information generation apparatus according to an embodiment of the present application.

FIG. 4 is a structural diagram of an electronic device according to an embodiment of the present application.

### DETAILED DESCRIPTION

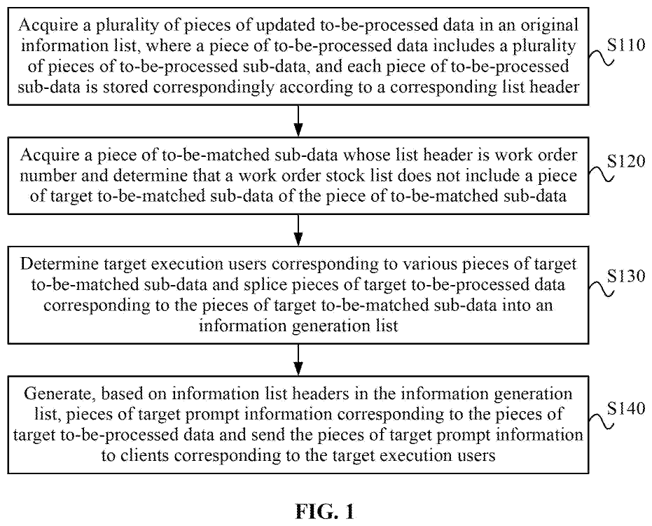

FIG. 1 is a flowchart of an information generation method according to an embodiment of the present application. This embodiment is applicable to the case of sending work order reminding information to a work order executor and determining whether the work order reminding information is received. The method may be performed by an information generation apparatus. The apparatus may be implemented by software and/or hardware. The hardware may be an electronic device, for example, a mobile terminal or a PC terminal.

As shown in FIG. 1, the method includes the following.

In S110, a plurality of pieces of updated to-be-processed data in an original information list are acquired. A piece of to-be-processed data includes a plurality of pieces of to-be-processed sub-data. Each piece of to-be-processed sub-data is stored correspondingly according to a corresponding list header.

The original information list may be understood as a list for recording work order task information. Multiple pieces of work order task information may be recorded in the original information list. Each piece of work order task information may include at least one piece of work order information of a work order serial number, a work order number, a work order type, a piece of work order content, or a unit to which a work order belongs. Pieces of to-be-processed data may be understood as pieces of work order data generated based on various pieces of work order information in various work order tasks.

It is to be noted that multiple list headers may be preset in the original information list. The name of each list header may match each piece of work order information. That is, each list header may be set to, for example, work order serial number, work order number, work order type, work order content, or unit to which a work order belongs.

In practical application, during the execution of the work order tasks, the pieces of to-be-processed data corresponding to the work order tasks may be recorded in the original information list. To guarantee that the pieces of to-be-processed data in the original information list are consistent with the actual execution of the work order tasks, the original information list needs to be continuously updated. In order to acquire pieces of execution information of the work order tasks in time and determine, according to the pieces of execution information, task execution nodes and work order execution users that currently correspond to the work order tasks, the pieces of to-be-processed data corresponding to the work order tasks may be acquired from the original information list. When the pieces of to-be-processed data in the original information list are acquired, the pieces of to-be-processed data may be acquired from the original information list according to a preset time interval; alternatively, the pieces of to-be-processed data may be acquired from the original information list when the pieces of work order task information in the original information list change.

For example, that the plurality of pieces of updated to-be-processed data in the original information list are acquired includes that each piece of to-be-processed data generated within the preset time interval is retrieved from a target database periodically and that the plurality of pieces of to-be-processed sub-data in the piece of to-be-processed data are stored correspondingly according to list headers in the original information list to process the plurality of pieces of updated to-be-processed data in the original information list.

The target database may be understood as a database that stores work order tasks, for example, a work order management system. Each work order task corresponds to at least one piece of work order information of a work order serial number, a work order number, a work order type, a piece of work order content, or a unit to which a work order belongs. Each to-be-processed sub-data may be understood as a piece of work order information corresponding to each list header.

For example, multiple work order tasks and pieces of work order information corresponding to the work order tasks are stored in the target database. To acquire the work order tasks and the pieces of work order information corresponding to the work order tasks in the target database, the robot process automation technology may be used to capture corresponding pieces of information from the target database, including at least one piece of work order information, corresponding to each work order task, of a work order serial number, a work order number, a work order type, a piece of work order content, or a unit to which a work order belongs. To guarantee that the pieces of information in the original information list are consistent with the actual execution of the work order tasks, each piece of to-be-processed data generated within the preset time interval may be retrieved from the target database periodically. For example, the preset time interval may be one hour or one day. Moreover, the pieces of acquired information are recorded in the original information list based on the robotic process automation technology. When the pieces of work order information acquired from the target database are stored in the original information list, each piece of work order information needs to be recorded and stored in a position matching a list header preset in the original information list so as to update the plurality of to-be-processed data in the original information list.

In S120, a piece of to-be-matched sub-data whose list header is “work order number” is acquired, and it is determined that a work order stock list does not include a piece of target to-be-matched sub-data of the piece of to-be-matched sub-data.

Each work order task has a matching work order number which may be understood as a piece of indicative information matching the work order task. The piece of to-be-matched sub-data may be understood as a work order number corresponding to a work order task recorded in the work order stock list. The work order stock list may be understood as a list used for recording work order numbers corresponding to pieces of work order reminding information already sent. That is, when a work order reminder corresponding to a certain work order task is already sent, a work order number corresponding to the work order task is stored in the work order stock list. The work order task with the corresponding work order reminder already sent can be queried through the work order stock list. When work order reminding is performed for the work order task, a piece of to-be-matched sub-data not queried in the work order stock list is taken as a piece of target to-be-matched sub-data.

For example, before work order reminders corresponding to various work order tasks are sent, pieces of to-be-matched sub-data whose list headers are work order number need to be acquired from the original information list; moreover, it is determined whether pieces of work order reminding information corresponding to various work order numbers are already sent so as to prevent the same work order task from being sent repeatedly. To determine whether the pieces of work order reminding information of the work order tasks corresponding to the work order numbers are already sent, the work order numbers recorded in the work order stock list may be queried to determine a work order task corresponding to the work order number not recorded in the work order stock list. The work order number not recorded is taken as a piece of target to-be-matched sub-data.

For example, that the piece of to-be-matched sub-data whose list header is “work order number” is acquired and it is determined that the work order stock list does not include the piece of target to-be-matched sub-data of the piece of to-be-matched sub-data includes that a plurality of pieces of to-be-matched sub-data whose list header is “work order number” are acquired; that it is determined based on a first target query function whether the work order stock list includes the piece of to-be-matched sub-data, where the work order stock list includes a work order number of a piece of target prompt information already sent; that in response to determining that the work order stock list includes the piece of to-be-matched sub-data, a piece of to-be-processed data to which the piece of to-be-matched sub-data belongs is removed from the original information list; and in response to determining that the work order stock list does not include the piece of to-be-matched sub-data, the piece of to-be-matched sub-data is taken as the piece of target to-be-matched sub-data.

The first target query function may be understood as a function for querying work order numbers in the work order stock list. For example, the first target query function may be “=IFERROR(VLOOKUP(B3,work order stock list!B:B,1,0),C” “)”. Each piece of target prompt information may be understood as a piece of reminding information corresponding to each work order task and may include at least one piece of work order information, corresponding to each work order task, of a work order serial number, a work order number, a work order type, a piece of work order content, or a unit to which a work order belongs.

For example, the plurality of pieces of to-be-matched sub-data whose list header is “work order number” are acquired from the original information list based on the set acquisition function. That is, a work order number corresponding to a work order task is acquired and then is queried in the work order stock list based on the first target query function to determine whether a work order number consistent with the acquired work order number exists in the work order stock list. If a consistent work order number exists in the work order stock list, it indicates that a piece of work order prompt information corresponding to the work order number is already sent and does not need to be sent again. In this case, a piece of to-be-processed data to which a piece of to-be-matched sub-data belongs is removed from the original information list. That is, a piece of work order information corresponding to a work order task consistent with the work order number is removed from the original information list. If no work order number consistent with the acquired work order number is found in the work order stock list, it indicates that the piece of work order prompt information corresponding to the work order number is not sent. The work order number is taken as a piece of target to-be-matched sub-data to determine, according to the piece of target to-be-matched sub-data, the work order task whose piece of prompt information needs to be sent.

In S130, target execution users corresponding to various pieces of target to-be-matched sub-data are determined, and pieces of target to-be-processed data corresponding to the pieces of target to-be-matched sub-data are spliced into an information generation list.

After the pieces of target to-be-matched sub-data are determined, various pieces of prompt information are sent to corresponding execution users. A target execution user may be understood as an execution user corresponding to a piece of target to-be-matched sub-data. The information generation list may be understood as an information template for generating pieces of prompt information. For example, the information generation list may be a preset information table or a preset information template. The information generation list may include multiple preset fields, including each keyword corresponding to at least one piece of work order information of a work order serial number, a work order number, a work order type, a piece of work order content, or a unit to which a work order belongs.

For example, when work order tasks and pieces of work order information corresponding to the work order tasks are acquired from the target database, the pieces of work order information include work order numbers and execution users corresponding to the work order numbers. Correspondingly, when the pieces of work order information are recorded in the original information list, the execution users corresponding to the work order numbers are also stored in the original information list. After the pieces of target to-be-matched sub-data are determined, that is, after the work order numbers corresponding to the work order tasks whose pieces of prompt information need to be sent, the target execution users corresponding to the pieces of target to-be-matched sub-data may be determined based on the correspondence between the work order numbers and the execution users. Then pieces of to-be-processed data corresponding to the pieces of target to-be-matched sub-data are acquired from the original information list. That is, pieces of work order information corresponding to various target work order numbers are acquired. The pieces of work order information are spliced based on the preset fields in the preset information generation list and filled in positions corresponding to the preset fields so as to obtain pieces of target prompt information corresponding to target work order tasks and send the pieces of target prompt information to the target execution users.

For example, that the target execution users corresponding to the pieces of target to-be-matched sub-data are determined includes that a work order execution user list is read based on a second target query function to determine the target execution users corresponding to the pieces of target to-be-matched sub-data.

The second target query function may be understood as a function for querying work order execution users in the work order execution user list. For example, the second target query function may be “=VLOOKUP(G3,work order processing user list!A:B.2,0)”. The work order execution user list may be understood as a list for recording work order execution users corresponding to various work order tasks. The work order execution user list includes work order numbers and the work order execution users corresponding to the work order numbers. That is, the work order execution users corresponding to the work order tasks may be determined according to the work order execution user list.

For example, the work order numbers corresponding to the work order tasks and the work order execution users corresponding to the work order tasks are pre-stored in the work order execution user list. A work order number and a work order execution user that correspond to the same work order task match each other. After a piece of target to-be-matched sub-data is determined, a work order execution user corresponding to the piece of target to-be-matched sub-data, that is, a target work order execution user corresponding to a target work order number, may be queried from the work order execution user list through the second target query function and the piece of target to-be-matched sub-data.

For example, that the pieces of target to-be-processed data corresponding to the pieces of target to-be-matched sub-data are spliced into the information generation list includes that a list header of the original information list is spliced on a list header in the information generation list to update the information generation list and that pieces of target to-be-processed sub-data to which the pieces of target to-be-matched sub-data belong are updated to the information generation list and matched with corresponding list headers.

In practical application, before the pieces of target prompt information are generated, the information generation list may be preset. Each list header in the information generation list corresponds to each list header in the original information list and may include at least one piece of work order information of a work order serial number, a work order number, a work order type, a piece of work order content, or a unit to which a work order belongs. When a piece of work order information in the original information list changes, a list header in the original information list is updated correspondingly. When it is detected that the list header in the original information list changes, the corresponding list header in the information generation list is updated to match the list header in the original information list. Then when the pieces of target prompt information are generated, the pieces of target to-be-processed sub-data corresponding to the pieces of target to-be-matched sub-data are determined. Moreover, the pieces of target to-be-processed sub-data are filled in positions matching various list headers in the information generation list based on the correspondence between the pieces of target to-be-processed sub-data and the list headers.

In S140, pieces of target prompt information corresponding to the pieces of target to-be-processed data are generated based on information list headers in the information generation list and sent to clients corresponding to the target execution users.

A work order task whose piece of work order prompt information needs to be sent is taken as a target work order task. A piece of target to-be-processed data may be understood as a piece of prompt information corresponding to a target work order task. A client corresponding to a target execution user may be a terminal device or a mobile terminal device.

For example, the pieces of target to-be-processed data corresponding to various pieces of list header information are filled in positions matching the pieces of list header information based on the pieces of list header information in the information generation list. Various pieces of to-be-processed data are spliced to generate the pieces of target prompt information corresponding to the pieces of target to-be-processed data. After the pieces of target prompt information are generated, the pieces of target prompt information may be sent to the clients corresponding to the target execution users to remind the target execution users of processing the corresponding target work order tasks.

For example, that the pieces of target prompt information corresponding to the pieces of target to-be-processed data are generated based on the information list headers in the information generation list includes that a reminding task is generated based on each piece of row data in the information generation list, that the reminding task and a piece of prompt information of a corresponding target execution user is sent to a target interaction group, and that the target execution user is prompted in a special reminding manner.

The information generation list includes pieces of row data and pieces of column data. A prompt task corresponding to a target work order task is recorded in a piece of row data and is generated based on a piece of target to-be-processed data corresponding to a list header in the information generation list. To facilitate the reminding of the work order execution users, one work order reminding group may be pre-created. The pre-created work order reminding group is taken as the target interaction group. When work order reminding needs to be performed for a work order execution user, a piece of target prompt information may be sent to the target interaction group, and a special prompt may be sent to the target execution user through a special reminding manner set in the target interaction group.

Exemplarily, the piece of target prompt information may be “[Work order reminding][032022010310032002] [consultation query][target address: [xxx power supply station] No. 18, xxx road]. The customer called to inquire about the electricity bill in November. The customer only provided the user number and the address, but the provided account name was inconsistent with the registered account name. An explanation was given. It was recommended that the customer makes verification before calling again. The customer did not accept it. Please make verification and follow up. Contact: Ms. 138xxxx. Please sign the work order in time. @ZHANG San”. “@ZHANG San” is the special reminding manner. It is to be noted that the piece of target prompt information is merely an example and is not an actual piece of target prompt information.

The original information list includes at least one piece of work order information of a work order serial number, a work order number, a work order type, a piece of work order content, or a unit to which a work order belongs. A list header matches a piece of work order information. The work order execution user list includes at least one to-be-selected execution user and a user identifier corresponding to each to-be-selected execution user.

According to the technical solution of this embodiment, a plurality of pieces of updated to-be-processed data in an original information list are acquired. Pieces of work order information corresponding to various work order tasks are acquired from a target database. Moreover, a plurality of pieces of to-be-processed data in the original information list are updated based on various acquired pieces of work order information so as to acquire the pieces of updated to-be-processed data from the original information list. A piece of to-be-matched sub-data whose list header is “work order number” is acquired, and it is determined that a work order stock list does not include a piece of target to-be-matched sub-data of the piece of to-be-matched sub-data. A work order number that corresponds to a piece of prompt information already sent and is pre-stored in the work order stock list is queried through a first target query function. A piece of to-be-matched sub-data not recorded in the work order stock list is taken as a piece of target to-be-matched sub-data so as to generate a piece of target prompt information based on a piece of to-be-processed data corresponding to the piece of target to-be-matched sub-data. Target execution users corresponding to various pieces of target to-be-matched sub-data are determined, and pieces of target to-be-processed data corresponding to the pieces of target to-be-matched sub-data are spliced into an information generation list. The pieces of target to-be-processed data corresponding to the pieces of target to-be-matched sub-data are spliced into the information generation list, and pieces of target prompt information are obtained based on the pieces of target to-be-processed data in the information generation list. The pieces of target prompt information corresponding to the pieces of target to-be-processed data are generated based on information list headers in the information generation list and sent to clients corresponding to the target execution users. A piece of prompt information is sent to a target interaction group, and a piece of prompt information is sent to a corresponding target execution user in a special reminding manner to remind the target execution user of processing a corresponding work order in time. Such an arrangement avoids the case in the related art that the content of a piece of work order reminding information sent through a short message is inaccurate, improving the accuracy of the content of the piece of work order reminding information. An accurate work order reminder can be generated automatically. Moreover, whether a work order executor receives the piece of work order reminding information can be determined.

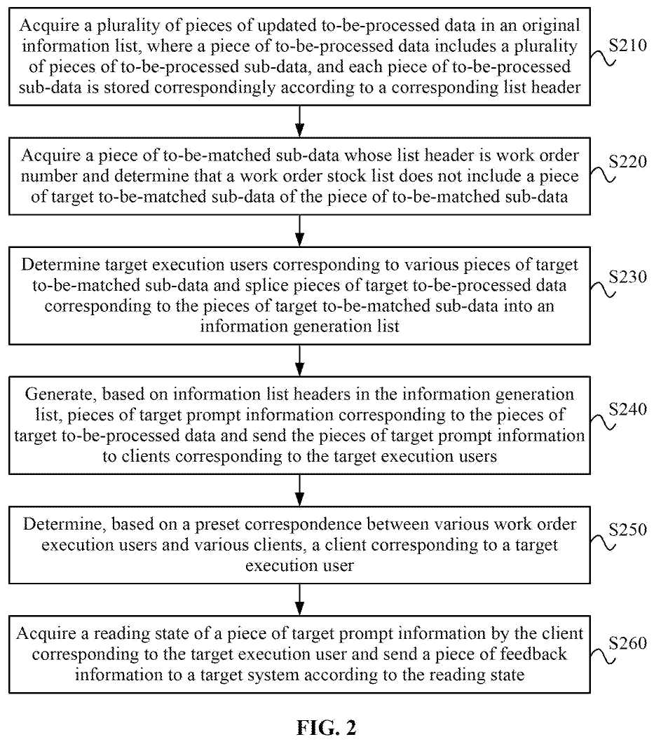

As an example embodiment of the preceding embodiment, FIG. 2 is a flowchart of the information generation method according to another embodiment of the present application. For example, after the piece of target prompt information is sent to the client corresponding to the target execution user, it may be determined according to a reading state of the piece of target prompt information by the client corresponding to the target execution user whether the target execution user already receives the piece of target prompt information.

As shown in FIG. 2, the method includes the following.

In S210, a plurality of pieces of updated to-be-processed data in an original information list are acquired. A piece of to-be-processed data includes a plurality of pieces of to-be-processed sub-data. Each piece of to-be-processed sub-data is stored correspondingly according to a corresponding list header.

In S220, a piece of to-be-matched sub-data whose list header is “work order number” is acquired, and it is determined that a work order stock list does not include a piece of target to-be-matched sub-data of the piece of to-be-matched sub-data.

In S230, target execution users corresponding to various pieces of target to-be-matched sub-data are determined, and pieces of target to-be-processed data corresponding to the pieces of target to-be-matched sub-data are spliced into an information generation list.

In S240, pieces of target prompt information corresponding to the pieces of target to-be-processed data are generated based on information list headers in the information generation list and sent to clients corresponding to the target execution users.

In S250, a client corresponding to a target execution user is determined based on a preset correspondence between various work order execution users and various clients.

For example, to facilitate the reminding of the target execution user, pieces of client identifier information used by the work order execution users are recorded in a work order execution user list. In this case, after the target execution user corresponding to a piece of target to-be-matched sub-data is determined, a piece of client identifier information corresponding to the target execution user can be determined. Then the client corresponding to the target execution user is determined according to the piece of client identifier information.

In S260, a reading state of a piece of target prompt information by the client corresponding to the target execution user is acquired, and a piece of feedback information is sent to a target system according to the reading state.

For example, after the piece of target prompt information is sent to a target interaction group, the reading state in the target interaction group may be listened to through a preset listening function in the target system. When the target execution user sends a piece of reply information regarding the piece of target prompt information, for example, “Copy that”, or after it is detected that the target execution user enters the target interaction group and browses the piece of target prompt information, the reading state of the piece of target prompt information may be set to “Read”. Then the reading state of the piece of target prompt information by the target execution user is sent to the target system to determine whether the target execution user already receives the piece of target prompt information.

For example, a piece of work order prompt information (that is, the piece of target prompt information) may be generated automatically with the adoption of this technical solution. Moreover, the piece of target prompt information is sent to a corresponding work order executor (that is, the target execution user). Then it is determined based on the reading state of the piece of target prompt information by the client corresponding to the target execution user whether the target execution user already receives the piece of target prompt information.

First, a work order original information list (that is, the original information list), the work order stock list, a work order short message generation list (that is, the information generation list), and a work order execution user list are pre-created. Corresponding fields are preset in the original information list, for example, work order serial number, work order number, work order type, work order content, and unit to which a work order belongs. Then pieces of work order information corresponding to the preset fields are acquired from a work order management system (that is, the target database) based on the robotic process automation (RPA) technology. Then the pieces of work order information (that is, a plurality of pieces of to-be-processed data) are stored in the original information list. A query is performed from the work order stock list based on a first target query function to determine whether a work order number consistent with a work order number (that is, a piece of to-be-matched sub-data) in the original information list exists in the work order stock list. Exemplarily, the query performed based on the first target query function may be “=IFERROR(VLOOKUP(B3,work order stock list!B:B,1,0),” “)”. If a work order number consistent with a work order number in the original information list exists in the work order stock list, it indicates that a piece of prompt information corresponding to the work order number is already sent and does not need to be sent again. In this case, a piece of to-be-processed data that corresponds to the piece of to-be-matched sub-data and is in the original information list is removed. If no work order number consistent with a work order number in the original information list exists in the work order stock list, the piece of to-be-matched sub-data is taken as a piece of target to-be-matched sub-data. Then a query is performed from the work order execution user list based on a second target query function to determine a target execution user corresponding to the piece of target to-be-matched sub-data. Exemplarily, the query performed based on the second target query function may be “=VLOOKUP(G3,work order processing user list!A:B,2,0)”. Then a piece of target to-be-processed data corresponding to the piece of target to-be-matched sub-data is determined according to a preset field in the original information list. The piece of target to-be-processed data is spliced and filled in the information generation list. Each piece of target to-be-processed data matches a corresponding list header in the information generation list. A corresponding piece of target prompt information is generated based on the splice sequence of the pieces of target to-be-processed data in the information generation list. Exemplarily, the piece of target prompt information may be “[Work order reminding][032022010310032002] [consultation query][target address: [xxx power supply station] No. 18, xxx road]. The customer called to inquire about the electricity bill in November. The customer only provided the user number and the address, but the provided account name was inconsistent with the registered account name. An explanation was given. It was recommended that the customer makes verification before calling again. The customer did not accept it. Please make verification and follow up. Contact: Ms. 138xxxx. Please sign the work order in time. @ZHANG San”. Then the piece of target prompt information is sent to the target interaction group. Then the target execution user is prompted in a special reminding manner. “(a ZHANG San” is the special reminding manner. It is to be noted that the piece of target prompt information is merely an example and is not an actual piece of target prompt information.

It is to be noted that after the piece of target prompt information is sent to the target interaction group, the target interaction group may be listened to based on the preset listening function in the target database to determine a reading state of the piece of target prompt information by a client corresponding to the target execution user. Moreover, it is determined based on the reading state corresponding to the client corresponding to the target execution user whether the target execution user already receives the piece of target prompt information.

According to the technical solution of this embodiment, a client corresponding to a target execution user is determined based on a preset correspondence between various work order execution users and various clients so that a reading state of a piece of target prompt information by the client corresponding to the target execution user is listened to after the piece of target prompt information is sent to a target interaction group. The reading state of the piece of target prompt information by the client corresponding to the target execution user is acquired, and a piece of feedback information is sent to a target system according to the reading state to determine according to the piece of feedback information whether the target execution user already receives the piece of target prompt information. Such an arrangement avoids the case in the related art that a work order reminder is sent through a short message and that it cannot be determined whether the target execution user already receives a piece of work order reminding information. With this arrangement, it can be determined according to the piece of feedback information of the client corresponding to the target execution user whether the target execution user already receives the piece of work order reminding information.

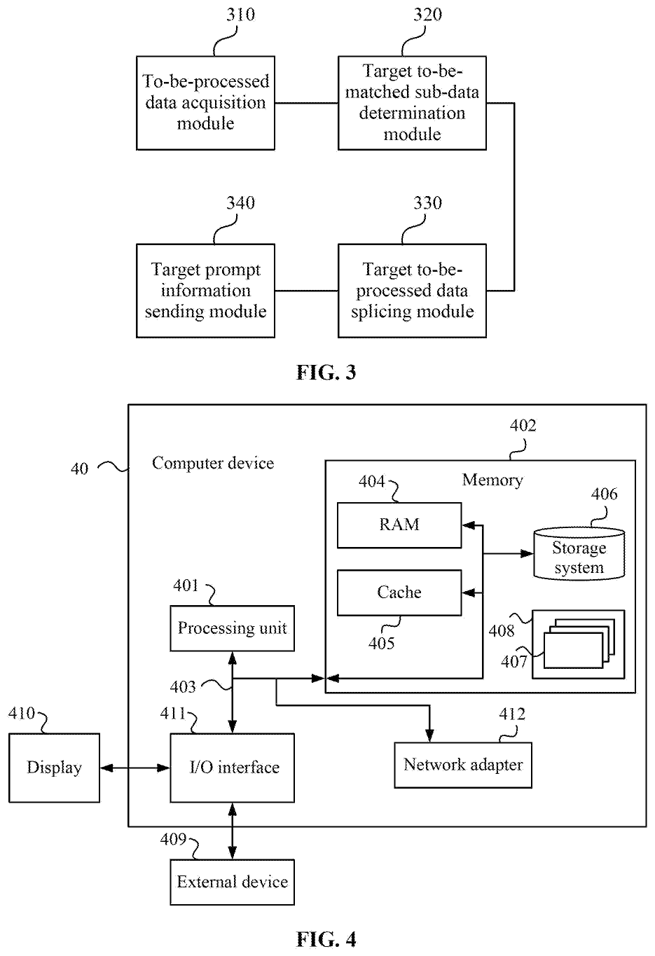

FIG. 3 is a structural diagram of an information generation apparatus according to an embodiment of the present application. The apparatus includes a to-be-processed data acquisition module 310, a target to-be-matched sub-data determination module 320, a target to-be-processed data splicing module 330, and a target prompt information sending module 340.

The to-be-processed data acquisition module 310 is configured to acquire a plurality of pieces of updated to-be-processed data in an original information list. A piece of to-be-processed data includes a plurality of pieces of to-be-processed sub-data. Each piece of to-be-processed sub-data is stored correspondingly according to a corresponding list header.

The target to-be-matched sub-data determination module 320 is configured to acquire a piece of to-be-matched sub-data whose list header is “work order number” and determine that a work order stock list does not include a piece of target to-be-matched sub-data of the piece of to-be-matched sub-data.

The target to-be-processed data splicing module 330 is configured to determine target execution users corresponding to various pieces of target to-be-matched sub-data and splice pieces of target to-be-processed data corresponding to the pieces of target to-be-matched sub-data into an information generation list.

The target prompt information sending module 340 is configured to generate, based on information list headers in the information generation list, pieces of target prompt information corresponding to the pieces of target to-be-processed data and send the pieces of target prompt information to clients corresponding to the target execution users.

According to the technical solution of this embodiment, a plurality of pieces of updated to-be-processed data in an original information list are acquired. Pieces of work order information corresponding to various work order tasks are acquired from a target database. Moreover, a plurality of pieces of to-be-processed data in the original information list are updated based on various acquired pieces of work order information so as to acquire the pieces of updated to-be-processed data from the original information list. A piece of to-be-matched sub-data whose list header is “work order number” is acquired, and it is determined that a work order stock list does not include a piece of target to-be-matched sub-data of the piece of to-be-matched sub-data. A work order number that corresponds to a piece of prompt information already sent and is pre-stored in the work order stock list is queried through a first target query function. A piece of to-be-matched sub-data not recorded in the work order stock list is taken as the piece of target to-be-matched sub-data so as to generate a piece of target prompt information based on a piece of to-be-processed data corresponding to the piece of target to-be-matched sub-data. Target execution users corresponding to various pieces of target to-be-matched sub-data are determined, and pieces of target to-be-processed data corresponding to the pieces of target to-be-matched sub-data are spliced into an information generation list. The pieces of target to-be-processed data corresponding to the pieces of target to-be-matched sub-data are spliced into the information generation list, and pieces of target prompt information are obtained based on the pieces of target to-be-processed data in the information generation list. The pieces of target prompt information corresponding to the pieces of target to-be-processed data are generated based on information list headers in the information generation list and sent to clients corresponding to the target execution users. A piece of prompt information is sent to a target interaction group, and a piece of prompt information is sent to a corresponding target execution user in a special reminding manner to remind the target execution user of processing a corresponding work order in time. Such an arrangement avoids the case in the related art that the content of a piece of work order reminding information sent through a short message is inaccurate, improving the accuracy of the content of the piece of work order reminding information.

For example, the to-be-processed data acquisition module includes a to-be-processed data acquisition sub-module and a to-be-processed data storage sub-module.

The to-be-processed data acquisition sub-module is configured to retrieve each piece of to-be-processed data generated within the preset time interval from a target database periodically.

The to-be-processed data storage sub-module is configured to store the plurality of pieces of to-be-processed sub-data in the piece of to-be-processed data correspondingly according to list headers in the original information list to process the plurality of pieces of updated to-be-processed data in the original information list.

For example, the target to-be-matched sub-data determination module includes a to-be-matched sub-data acquisition sub-module, a to-be-matched sub-data determination sub-module, a to-be-matched sub-data removal sub-module, and a target to-be-matched sub-data determination sub-module.

The to-be-matched sub-data acquisition sub-module is configured to acquire a plurality of pieces of to-be-matched sub-data whose list header is “work order number”.

The to-be-matched sub-data determination sub-module is configured to determine based on a first target query function whether the work order stock list includes the piece of to-be-matched sub-data. The work order stock list includes a work order number of a piece of target prompt information already sent.

The to-be-matched sub-data removal sub-module is configured to, in response to determining that the work order stock list includes the piece of to-be-matched sub-data, remove a piece of to-be-processed data to which the piece of to-be-matched sub-data belongs from the original information list.

The target to-be-matched sub-data determination sub-module is configured to, in response to determining that the work order stock list does not include the piece of to-be-matched sub-data, take the piece of to-be-matched sub-data as the piece of target to-be-matched sub-data.

For example, the target to-be-processed data splicing module is configured to read a work order execution user list based on a second target query function to determine the target execution users corresponding to the pieces of target to-be-matched sub-data.

For example, the target to-be-processed data splicing module includes a list header splicing sub-module and a list header matching sub-module.

The list header splicing sub-module is configured to splice a list header of the original information list on a list header in the information generation list to update the information generation list.

The list header matching sub-module is configured to update pieces of target to-be-processed sub-data to which the pieces of target to-be-matched sub-data belong to the information generation list and match the pieces of target to-be-processed sub-data with corresponding list headers.

For example, the target prompt information sending module is configured to generate a reminding task based on each piece of row data in the information generation list, send the reminding task and a piece of prompt information of a corresponding target execution user to a target interaction group, and prompt the target execution user in a special reminding manner.

For example, the information generation apparatus further includes a target execution user determination module and a feedback information sending module.

The target execution user determination module is configured to determine a client corresponding to a target execution user based on a preset correspondence between various work order execution users and various clients.

The feedback information sending module is configured to acquire a reading state of a piece of target prompt information by the client corresponding to the target execution user and send a piece of feedback information to a target system according to the reading state.

For example, the original information list includes at least one piece of work order information of a work order serial number, a work order number, a work order type, a piece of work order content, or a unit to which a work order belongs. A list header matches a piece of work order information. The work order execution user list includes at least one to-be-selected execution user and a user identifier corresponding to each to-be-selected execution user.

The information generation apparatus provided in this embodiment of the present application may perform the information generation method provided in any embodiment of the present application and has functional modules and beneficial effects corresponding to the performed method.

It is to be noted that units and modules included in the preceding apparatus are divided according to function logic but are not limited to such division, as long as the corresponding functions can be achieved. Moreover, the specific names of function units are used for distinguishing between each other and not intended to limit the scope of embodiments of the present application.

FIG. 4 is a structural diagram of an electronic device according to an embodiment of the present application. FIG. 4 shows a block diagram of an example electronic device 40 for implementing embodiments of the present application. The electronic device 40 shown in FIG. 4 is merely an example and is not intended to limit the function and use scope of embodiments of the present application.

As shown in FIG. 4, the electronic device 40 may take a form of a general-purpose computer device. Components of the electronic device 40 may include, but is not limited to, one or more processors or processing units 401, a system memory 402, and a bus 403 connecting different system components (including the system memory 402 and the one or more processing units 401).

The bus 403 represents one or more of several-type bus structures, including a memory bus or memory controller, a peripheral bus, an accelerated graphics port and a processor, or represents a local bus using any one of multiple bus structures. For example, these architectures include, but are not limited to, an industry subversive alliance (ISA) bus, a micro channel architecture (MAC) bus, an enhanced ISA bus, a video electronics standards association (VESA) local bus, and a peripheral component interconnect (PCI) bus.

The electronic device 40 typically includes multiple computer system readable media. These media may be available media that can be accessed by the electronic device 40. These media include volatile and non-volatile media, and removable and non-removable media.

The storage apparatus 402 may include a computer system readable medium in the form of a volatile memory, such as a random access memory (RAM) 404 and/or a cache memory 405. The electronic device 40 may include other removable/non-removable, volatile/non-volatile computer system storage media. Just exemplarily, the storage system 406 may be configured to perform reading and writing on a non-removable and non-volatile magnetic medium (not shown in FIG. 4 and usually referred to as a “hard disk driver”). Although not shown in FIG. 4, it is feasible to provide not only a magnetic disk driver for performing reading and writing on a removable non-volatile magnetic disk (for example, a “floppy disk”), but also an optical disk driver for performing reading and writing on a removable non-volatile optical disk, such as a compact disc read-only memory (CD-ROM), a digital video disc-read only memory (DVD-ROM) or other optical media. In these cases, each drive may be connected to the bus 403 through one or more data media interfaces. The memory 402 may include at least one program product having a group of program modules (for example, at least one program module). These program modules are configured to perform functions of various embodiments of the present application.

A program/utility 408 having a group of program modules 407 (at least one program module 407) may be stored, for example, in the memory 402. Such program modules 407 include, but are not limited to, an operating system, one or more application programs, other program modules and program data. Each or some combinations of these examples may include implementation of a network environment. The program modules 407 generally execute the functions and/or methods in the embodiments of the present application.

The electronic device 40 may communicate with one or more external devices 409 (for example, a keyboard, a pointing terminal, a displayer 410). The electronic device 40 may communicate with one or more terminals that enable a user to interact with the electronic device 40, and/or with any device (for example, a network card or a modem) that enables the electronic device 40 to communicate with one or more other computing devices. These communications may be performed through an input/output (I/O) interface 411. Moreover, the electronic device 40 may communicate with one or more networks (such as a local area network (LAN), a wide area network (WAN) and/or a public network, for example, the Internet) through a network adapter 412. As shown in the figure, the network adapter 412 communicates with other modules of the electronic device 40 via the bus 403. It is to be understood that although not shown in FIG. 4, other hardware and/or software modules may be used in conjunction with the electronic device 40. The other hardware and/or software modules include, but are not limited to, microcodes, a terminal driver, a redundant processing unit, an external disk drive array, an RAID system, a tape driver, a data backup storage system and the like.

The one or more processing units 401 execute a program stored in the system memory 402 to perform various functional applications and data processing, for example, to perform the information generation method provided in embodiments of the present application.

An embodiment of the present application provides a storage medium including computer-executable instructions which, when executed by a computer processor, are used for performing an information generation method. The method includes the following.

A plurality of pieces of updated to-be-processed data in an original information list are acquired. A piece of to-be-processed data includes a plurality of pieces of to-be-processed sub-data. Each piece of to-be-processed sub-data is stored correspondingly according to a corresponding list header.

A piece of to-be-matched sub-data whose list header is “work order number” is acquired, and it is determined that a work order stock list does not include a piece of target to-be-matched sub-data of the piece of to-be-matched sub-data.

Target execution users corresponding to various pieces of target to-be-matched sub-data are determined, and pieces of target to-be-processed data corresponding to the pieces of target to-be-matched sub-data are spliced into an information generation list.

Pieces of target prompt information corresponding to the pieces of target to-be-processed data are generated based on information list headers in the information generation list and sent to clients corresponding to the target execution users.

A computer storage medium in the embodiments of the present application may adopt any combination of one or more computer-readable media. The computer-readable medium may be a computer-readable signal medium or a computer-readable storage medium. The computer-readable storage medium may be, for example, but not limited to, an electrical, magnetic, optical, electromagnetic, infrared, or semiconductor system, apparatus, or device, or any combination thereof. More specific examples of the computer-readable storage medium include (non-exhaustive list) an electrical connection having one or more wires, a portable computer magnetic disk, a hard disk, a random access memory (RAM), a read only memory (ROM), an erasable programmable read only memory (EPROM or flash memory), an optical fiber, a portable compact disk read only memory (CD-ROM), an optical memory device, a magnetic memory device, or any suitable combination thereof. In this document, the computer-readable storage medium may be any tangible medium including or storing a program. The program may be used by or used in conjunction with an instruction execution system, apparatus, or device.

The computer-readable signal medium may include a data signal propagated in a baseband or as part of a carrier. Computer-readable program codes are carried in the data signal. The data signal propagated in this manner may be in multiple forms and includes, but is not limited to, an electromagnetic signal, an optical signal, or any suitable combination thereof. The computer-readable signal medium may be any computer-readable medium other than the computer-readable storage medium. The computer-readable medium may send, propagate, or transmit a program used by or used in conjunction with an instruction execution system, apparatus, or device.

Program codes contained in the computer-readable medium may be transmitted via any suitable medium. The medium includes, but is not limited to, the wireless, a wire, an optical cable, the radio frequency (RF) or the like, or any suitable combination thereof.

Computer program codes for performing the operations of embodiments of the present application may be written in one or more programming languages or a combination thereof, the programming languages including object-oriented programming languages such as Java, Smalltalk, C++ and further including conventional procedural programming languages such as C programming language or similar programming languages. Program codes may be executed entirely on a user computer, executed partly on a user computer, executed as a stand-alone software package, executed partly on a user computer and partly on a remote computer or executed entirely on a remote computer or a server. In the case relating to the remote computer, the remote computer may be connected to the user computer via any type of network including a local area network (LAN) or a wide area network (WAN), or may be connected to an external computer (for example, via the Internet through an Internet service provider).

1. An information generation method, comprising:
acquiring a plurality of pieces of updated to-be-processed data in an original information list, wherein each piece of the to-be-processed data refers to work order data generated based on work order information and each piece of the to-be-processed data comprises a plurality of pieces of to-be-processed sub-data, and each piece of the to-be-processed sub-data is stored correspondingly according to a list header corresponding to each piece of the to-be-processed sub-data;
acquiring pieces of to-be-matched sub-data whose list header is a work order number and determining that a work order stock list does not comprise target to-be-matched sub-data of the to-be-matched sub-data, wherein each piece of the to-be-matched sub-data refers to a work order number corresponding to a work order task recorded in the work order stock list, and the work order stock list refers to a list used for recording work order numbers for which work order prompt information has already been sent;
determining a target execution user corresponding to each piece of the target to-be-matched sub-data and splicing target to-be-processed data corresponding to each piece of the target to-be-matched sub-data into an information generation list; and
generating, based on an information list header in the information generation list, target prompt information corresponding to each piece of the target to-be-processed data and sending the target prompt information to a client corresponding to the target execution user.

2. The information generation method according to claim 1, wherein acquiring the plurality of pieces of updated to-be-processed data in the original information list comprises:
retrieving each piece of to-be-processed data generated within a preset time interval from a target database periodically; and
storing the plurality of pieces of to-be-processed sub-data in each piece of to-be-processed data correspondingly according to list headers in the original information list to process the plurality of pieces of updated to-be-processed data in the original information list.

3. The information generation method according to claim 2, wherein acquiring the pieces of to-be-matched sub-data whose list header is a work order number and determining that a work order stock list does not comprise the target to-be-matched sub-data of the to-be-matched sub-data comprises:
acquiring a plurality of pieces of to-be-matched sub-data whose list header is a work order number;
determining, based on a first target query function, whether the work order stock list comprises each piece of the to-be-matched sub-data, wherein the work order stock list comprises a work order number for which the target prompt information has already been sent;
in response to determining that the work order stock list comprises each piece of the to-be-matched sub-data, removing a piece of to-be-processed data to which each piece of the to-be-matched sub-data belongs from the original information list; and
in response to determining that the work order stock list does not comprise each piece of the to-be-matched sub-data, taking each piece of the to-be-matched sub-data as the target to-be-matched sub-data.

4. The information generation method according to claim 1, wherein determining the target execution user corresponding to each piece of the target to-be-matched sub-data comprises:
reading a work order execution user list based on a second target query function to determine the target execution user corresponding to each piece of the target to-be-matched sub-data.

5. The information generation method according to claim 1, wherein splicing the target to-be-processed data corresponding to each piece of the target to-be-matched sub-data into the information generation list comprises:
splicing a list header of the original information list on a list header in the information generation list to update the information generation list; and
updating target to-be-processed sub-data to which each piece of the target to-be-matched sub-data belongs to the information generation list and matching the piece of target to-be-processed sub-data with a list header corresponding the target to-be-processed sub-data.

6. The information generation method according to claim 1, wherein generating, based on the information list header in the information generation list, the target prompt information corresponding to each piece of the target to-be-processed data comprises:
generating a reminding task based on each piece of row data in the information generation list, sending the reminding task and a piece of prompt information of a corresponding target execution user to a target interaction group, and prompting the target execution user in a special reminding manner.

7. The information generation method according to claim 1, further comprising:
determining the client corresponding to the target execution user based on a preset correspondence between work order execution users and clients; and
acquiring a reading state of the piece of target prompt information by the client corresponding to the target execution user and sending a piece of feedback information to a target system according to the reading state.

8. The information generation method according to claim 1, wherein the original information list comprises at least one piece of work order information of a work order serial number, a work order number, a work order type, a piece of work order content, or a unit to which a work order belongs; the list header matches one of the at least one piece of work order information;
and a work order execution user list comprises at least one to-be-selected execution user and a user identifier corresponding to each of the at least one to-be-selected execution user.

9. An information generation apparatus, comprising:
a to-be-processed data acquisition module configured to acquire a plurality of pieces of updated to-be-processed data in an original information list, wherein each piece of the to-be-processed data refers to work order data generated based on work order information and each piece of the to-be-processed data comprises a plurality of pieces of to-be-processed sub-data, and each piece of the to-be-processed sub-data is stored correspondingly according to a list header corresponding to each piece of the to-be-processed sub-data;
a target to-be-matched sub-data determination module configured to acquire pieces of to-be-matched sub-data whose list header is a work order number and determine that a work order stock list does not comprise target to-be-matched sub-data of the to-be-matched sub-data wherein each piece of the to-be-matched sub-data refers to a work order number corresponding to a work order task recorded in the work order stock list, and the work order stock list refers to a list used for recording work order numbers for which work order prompt information has already been sent;
a target to-be-processed data splicing module configured to determine a target execution user corresponding to each piece of the target to-be-matched sub-data and splice target to-be-processed data corresponding to each piece of the target to-be-matched sub-data into an information generation list; and
a target prompt information sending module configured to generate, based on an information list header in the information generation list, target prompt information corresponding to each piece of the target to-be-processed data and send the target prompt information to a client corresponding to the target execution user.

10. An electronic device, comprising:
one or more processors; and
a storage apparatus configured to store one or more programs;
wherein when executed by the one or more processors, the one or more programs cause the one or more processors to perform the information generation method according to claim 1.
